(19) United States
(12) Patent Application Publication
(10) Pub. No.: US 2007/0034462 A1
(43) Pub. Date: Feb. 15, 2007

(54) Ventilated brake pads

(76) Inventors: Luc Themelin, Mery Sur Oise (FR); Jean-Claude Cottin, Beauchamp (FR); Herve Mace, Le Chesnay (FR); Delphine Deprez, Nanterre (FR); Loic Lelievre, Colombes (FR)

Correspondence Address: DENNISON, SCHULTZ & MACDONALD, 1727 KING STREET, SUITE 105, ALEXANDRIA, VA, 22314, US

(21) Appl. No.: 10/551,380

(22) PCT Filed: Mar. 30, 2004
(86) PCT No.: PCT/FR04/00794

§ 371 Date: Jan. 27, 2006

(30) Foreign Application Priority Data
Apr. 2, 2003 (FR) 03/04090

(51) Int. Cl. F16D 65/827

(52) U.S. Cl. 188/264 R; 188/264 A

(57) ABSTRACT

A disc brake pad including a brake lining having at least one friction surface, and provided with a heat dissipating structure which circulates the heat to be dissipated in one or more directions substantially parallel to the plane of the friction surface. The structure is arranged in the lining and/or in a carrier plate if there is one, or at the interface. The structure may be formed from cylindrical holes with axes following one or more directions substantially parallel to the friction surface. These holes are through holes, such that the air can freely pass therethrough. The structure may also be formed from projections at the periphery of the carrier plate, optionally fitted with cooling fins, or bars which are good heat conductors enclosed a component of the pad.

### FIELD OF THE INVENTION

This invention relates to disc brake linings, and more precisely to disc brake pads. Pads are disc brake elements generally located on each side of the disk, grouped in a stirrup straddling over the edge of the disk. Each pad is associated with one or several brake pistons. They are actuated by this or these pistons and are moved by the pressure of the braking fluid such that they come into contact with the disc surface, the disc typically being fixed to a vehicle wheel or a machine flywheel (wind generator, conveyor belt, etc.). The resulting friction reduces the rotation speed of the assembly.

### DESCRIPTION OF RELATED ART

The disc brake pads comprise a lining that is a wear element designed to come into contact with a face of the disc and a carrier plate, usually made of a different material, that will fix the stirrup and the brake pads together. The element that fixes the stirrup and the pads is occasionally a part of the lining and machined in body, particularly for linings made of a C/C composite. To facilitate the description, we will refer to this part of the lining and to the carrier plates in the general case, as the “attachment plate”.

The carrier plate is usually made of metal so as to resist mechanical forces generated by braking; it must firstly transmit—and resist—compression applied by the piston(s) on the lining and also hold the pad in contact on the disc despite high shear forces applied by the disc on the pad.

The material from which the lining is made is a friction material, typically based on an organic mix (actually a mix of graphite, ceramic powders and metallic chips bonded by a resin), based on a sintered material (mix of graphite, metal and ceramic powders), or a C/C type composite material like that described in patent EP 0 581 696. The organic lining is either glued onto the pad or moulded directly on the carrier plate that was previously perforated by a few anchor holes. The sintered lining is usually brazed on the carrier plate and the C/C composite lining is machined in the body.

The reduction in kinetic energy of the rotating assembly requires large friction forces that can cause intense temperature rise at the contact between the lining and the disk. As the thermal energy resulting from braking is dissipated, it causes large temperature rises at the disc and at the piston and the braking fluid. These temperature rises can cause malfunctions of the brake (degradation of the lining material, poor leak tightness at the contact between the piston and its housing, boiling and/or degradation of the braking fluid, etc.).

Many measures have already been proposed to reduce some of these disadvantages. For example, attempts have been made to reduce the thermal flux towards the piston and the cooling fluid to reduce effects on them, by choosing a lining material with the best possible thermal insulation (JP 05 171 167), a carrier plate material with the best possible thermal insulation (U.S. Pat. No. 4,230,207, JP 56 147 933), or by placing a heat shield between the carrier plate and the piston (JP 55 139 532, JP 58 156 735, GB 2 129 511, U.S. Pat. No. 3,490,563), between the lining and the carrier plate (JP 57 195 935) or between the carrier plate and a piece of sheet metal fixed on the plate and designed to be brought into contact with the piston (GB 2 020 763, U.S. Pat. No. 3,563,347).

### PROBLEM TO BE SOLVED

Introduction of a heat shield opposing the transfer of the heat flux towards the braking circuit has the advantage that it protects the piston and the braking fluid. However, the disc and the lining are not protected by the heat shield. It is even possible that temperature rises are greater than they would be without a heat shield. The result is that the disk, the brake lining and/or the means of attachment of the said lining onto the carrier plate are deteriorated prematurely.

Therefore the applicant attempted to develop a brake pad that does not have the disadvantages mentioned above, but does protect the pistons and the hydraulic braking circuit from any unexpected temperature rises.

### SUMMARY OF THE INVENTION

The purpose of the invention is a disc brake pad comprising at least one brake lining with at least one plane surface that will come into friction contact on one face of the disk—the said surface is called “friction surface” in the following description—which is provided with a heat dissipating structure directing the heat flux to be dissipated in at least one direction substantially parallel to the plane of the said friction surface. This structure is formed in the pad such that it directs the flux to be dissipated by conduction and/or by convection, in one or several particular directions substantially parallel to the plane of the friction surface, in other words substantially perpendicular to the direction in which the piston moves.

This heat dissipating structure is formed in the pad, either in the carrier plate or in the lining or in both, for example at their interface, and increases the cooling flux either by increasing the exchange surface area between the pad and the surrounding air, or by increasing the thermal conductivity in one or several directions substantially parallel to the friction surface.

For example, the increase in the heat exchange surface area with the surrounding air may be made by making perforations of oblong holes in the carrier plate and/or the pad, in other words elongated holes typically in the form of cylinders with a cross-section that is not necessarily circular. These holes move along one or several directions substantially parallel to the friction surface. They are through holes such that air can pass through them freely. The exchange surface area may also be increased by forming projections around the periphery of the carrier plate, the said projections being preferably provided with cooling fins oriented along the direction of the moving air. The two solutions—perforations+projections—may advantageously be combined, since the carrier plate and the lining are required to resist high mechanical stresses and cannot be perforated excessively.

The through holes formed in the pad are preferably cylindrical holes with axes substantially parallel to the plane of the friction surface. When the brake pad is installed on a moving vehicle, the axes of these holes are preferably substantially parallel to the same direction chosen as a function of the position of the disc brake with respect to the vehicle, and more precisely with respect to the direction of the moving air arriving close to the brake pad. In other words, these holes are preferably oriented in a direction parallel to the incoming air. For example, if there are no deflectors, “radial” holes will be chosen oriented globally towards the disc rotation axis if the stirrup is placed in front of the wheel rotation axis and “orthoradial”, in other words oriented along a direction tangential to the rotation of the disc if the stirrup is placed above the wheel rotation axis.

These holes may be cylindrical holes made in the body of the carrier plate and/or the lining. The diameter of the perforations is preferably as large as possible since it is not very easy to make such holes by drilling. In this case, it is important to check that the diameter of the perforations is compatible with the strength of the carrier plate and/or the lining required to resist the high mechanical stresses imposed by braking.

The holes may also correspond to grooves formed on the surface of the lining that will come into contact with the carrier plate and/or grooves formed on the surface of the carrier plate that will come into contact with the lining because the plane of one of these surfaces is usually parallel to the plane of the friction surface. Obviously, grooves could be formed on both surfaces such that they are facing each other when the lining and the carrier plate are assembled and thus form larger cavities, more easily accessible to moving air. The grooves have the advantage that they can be made by means other than drilling in body. Thus, a larger number of channels can thus be made without too much difficulty, increasing the exchange surface area. A larger number of channels with a smaller diameter but large enough for moving air to pass freely through them provides a better compromise between ventilation and the mechanical strength.

The carrier plate may also be provided with projections around its periphery. In this case, these projections are limited to the available volume; they must not come into contact with the disc or part of the stirrup, or even with the piston housing, during the movement of the pad imposed by the piston. Preferably, these projections are extensions of the carrier plate substantially along the plane of the carrier plate at its periphery. Depending on the available volume, these extensions can be fitted with fins that are substantially perpendicular to the plane of the pad and are oriented along a direction substantially parallel to the direction of the moving air at the pad. The plane of the carrier plate is usually parallel to the plane of the friction surface and the increase in the metallic mass in the plane of the carrier plate and near its periphery facilitates transfer of heat flux by conduction parallel to the plane of the friction surface, this flux being higher when these projections are actively cooled by moving air.

The increase in thermal conductivity in one or several directions substantially parallel to the plane of the friction surface may for example be increased by providing the brake lining and/or the carrier plate with bars made of a material conducting heat better than the material from which the lining and/or the carrier plate that contains these bars is made. Thus, oblong holes can be formed in the said pad and/or the said carrier plate as described above and these holes can then be filled with bars that are good conductors of heat. These holes may be either perforated in body, or machined in the form of grooves on the surface that acts as an interface between the carrier plate and the lining. As above, the carrier plate and the lining may be provided with facing grooves. The perforations thus obtained are filled with bars with a complementary shape composed of a material that is a good conductor of heat, typically copper bars. Cooling by ambient air is preferred, for example using hollow bars that pass from one side of the pad to the other. These bars can also be extended such that they are longer than the housings formed in the pad to contain them and they can be provided with a projection, typically cooling fins, to increase their exchange surface area. This arrangement improves the transfer of a heat flux by conduction parallel to the plane of the friction surface, this flux being greater when the bars are extended by projections actively cooled by moving air.

The heat dissipating structure characteristic of this invention may advantageously be combined with heat shields according to prior art that in particular will protect the brake cylinder, the braking fluid and the piston.

In the case of a pad with a lining made of a C/C composite that does not include a carrier plate, the holes are preferably drilled directly in the composite material close to the face oriented towards the piston.

There are many possible embodiments of the invention. We have described four particular examples in the following as non-limitative illustrations of the invention.

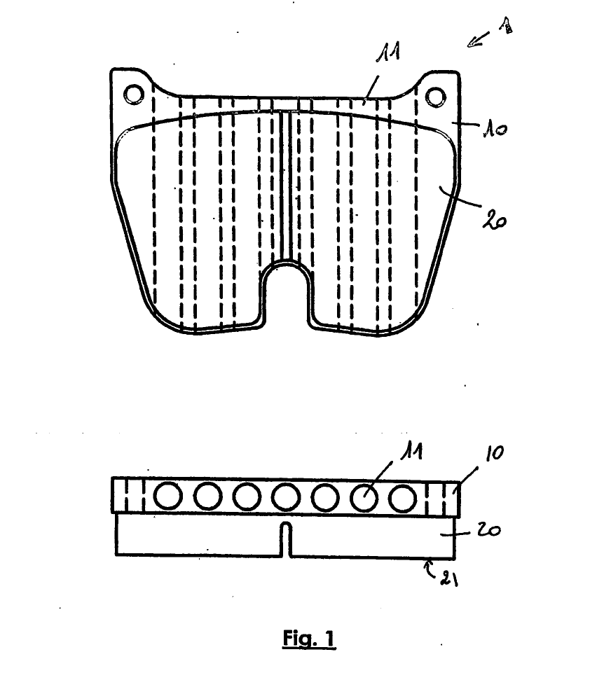

FIG. 1 shows a front view (a) and a top view (b), of a first pad according to the invention.

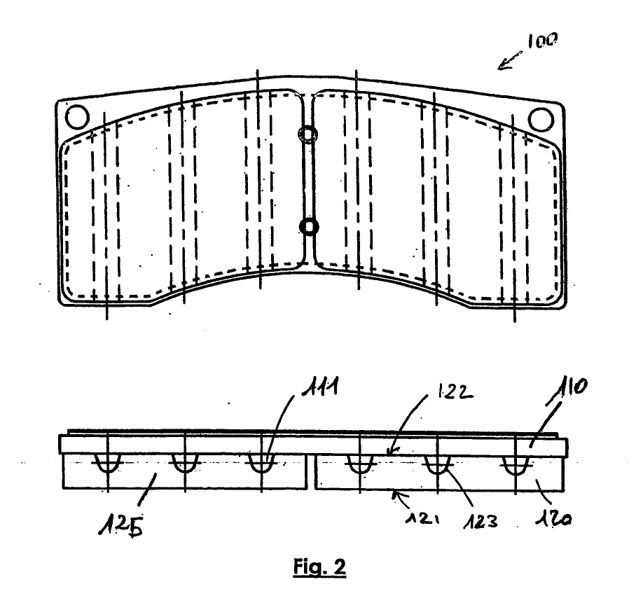

FIG. 2 shows a front view (a) and a top view (b), of a second pad according to the invention.

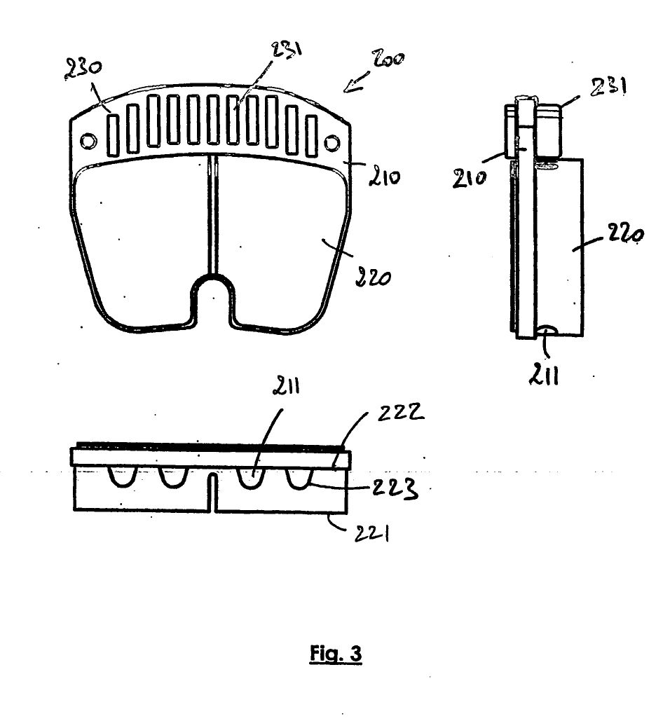

FIG. 3 shows a front view (a), a top view (b) and a side view (c) of a third pad according to the invention, with a lining for example with the same geometry as the lining in the first example.

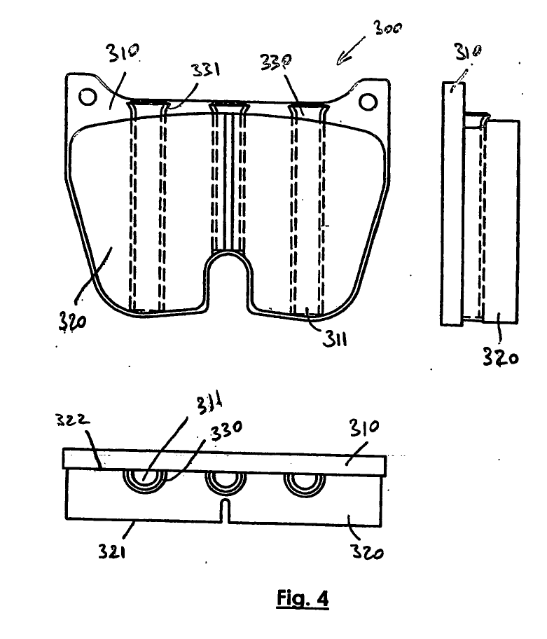

FIG. 4 shows a front view (a), a top view (b) and a side view (c) of a fourth pad according to the invention, with a lining for example with the same geometry as the lining in the first example.

### EXAMPLES

### Example 1

### Pad with a Perforated Carrier Plate (FIG. 1)

FIG. 1 shows a disc brake pad 1 with a steel carrier plate 10 and a sintered brake lining 20 that has a plane surface 21 that will come into friction contact on one face of the disk, called the friction surface. The brake lining 20 is fixed to the carrier plate 10 by brazing.

The heat dissipating structure is obtained by perforating holes 11 in the carrier plate 10 along a direction substantially parallel to the friction surface 21. These holes are through holes; they pass through the carrier plate 10 from one side to the other such that air can pass through them freely. They are cylindrical holes parallel to each other and with an axis substantially parallel to the plane of the friction surface. These holes are oriented parallel to the air inlet.

The thickness of the carrier plate 10 is typically 8 mm and it is inscribed within an substantially 80*60 mm rectangle. The diameter of the seven holes 11 is 6 mm, so that the carrier plate can equally well resist the pressure applied by the piston and the high tangential forces applied during braking; the minimum cross-section having to resist shear forces is still 40% greater than the cross-section of the non-perforated carrier plate.

### Example 2

### Pad with a Ventilated Lining (FIG. 2)

FIG. 2 shows a disc brake pad 100 with a shape different from the above. It also includes a steel carrier plate 110 and two sintered brake linings 120 and 125. The linings have a friction surface 121, with a total extent about 70% greater than the extent of the friction surface of the lining in example 1. The brake linings 120 and 125 are fixed to the carrier plate 110 by brazing.

In this example, the heat dissipating structure has been formed in the brake lining 120 (or 125) or more precisely at the contact between the brake lining and the carrier plate. Linear grooves 123 parallel to each other have been made on the surface 122 of the lining opposite the friction surface 121, along a direction substantially parallel to the friction surface 121. Once the brake lining 120 (or 125) has been assembled to the carrier plate 110, the grooves 123 and the wall of the carrier plate form holes 111 parallel to each other, passing through the pad from one side to the other such that air can pass freely through them. The axis of these holes is substantially parallel to the plane of the friction surface 121. As in the previous example, the general direction of these holes faces the stirrup air inlet.

The depth of the grooves 123 is of the order of 5 mm, while the thickness of the lining is substantially 9 mm.

### Example 3

### Pad with a Ventilated Lining and a Carrier Plate with a Peripheral Projection Fitted with Cooling Fins (FIG. 3)

FIG. 3 shows a disc brake pad 200 with a steel carrier plate 210 and a sintered brake lining 220 that is provided with a friction surface 221. The brake lining 220 is fixed onto the carrier plate 210 by brazing.

As in the previous example, the heat dissipating structure has been formed in the brake lining 220, or more precisely at the contact between the brake lining and the carrier plate. Linear grooves 223 parallel to each other were formed on the surface 222 of the lining opposite the friction surface 221 along a direction substantially parallel to the friction surface 221. Once the brake lining 220 has been assembled to the carrier plate 210, the grooves 223 and the wall of the carrier plate form holes 211 parallel to each other, passing through the pad from one side to the other such that air can pass freely through them. The axis of these holes is substantially parallel to the plane of the friction surface 221. As in the previous examples, the general direction of these holes faces the stirrup air inlet.

The depth of the grooves 223 is of the order of 6 mm, while the thickness of the lining is about 13 mm.

The exchange area is also increased by a projection 230 around the periphery of the carrier plate 210. This projection increases the mass of the carrier plate by about 50%. This increase is entirely located at the periphery of the carrier plate, which facilitates cooling of the lining by transverse conduction in the carrier plate.

The projection 230 is provided with cooling fins 231 to increase the lateral conduction flux.

### Example 4

### Pad with a Lining Through Which Copper Bars Pass (FIG. 4)

FIG. 4 shows a disc brake pad 300 with a steel carrier plate 310 and a sintered brake lining 320 provided with a friction surface 321. The brake lining 320 is fixed to the carrier plate 310 by brazing.

The heat dissipating structure is obtained by forming parallel cylindrical semi-circular grooves on the surface 322 of the lining 320 opposite the friction surface 321. Once the brake lining 320 has been assembled onto the carrier plate 310, the grooves form housings with the wall of the carrier plate 310 that will be occupied by copper bars 330, themselves cylindrical semi-circular, with a diameter that matches the diameter of the grooves, such that the contact between the bar and the lining provides the lowest possible resistance to heat transfers by conduction.

In the special case in this example, the copper bars 330 are not solid; they are hollow tubes that also allow air to pass freely through the pad from one side to the other, through holes 311. The bars 330 are prolonged such that they are longer than the housings formed in the pad. They are shown in FIG. 4 with a simply flared end 331. It would be possible to image more complex forms, for example the bars being connected at their ends by a projection similar to the that described in example 3.

1. Disc brake pad comprising at least one brake lining and a carrier-plate, the said lining having at least one plane surface designed to come into friction contact on one face of the disk, the said brake pad being provided with a heat dissipating structure which directs the heat flux to be dissipated in at least one direction substantially parallel to the plane of the said friction surface, wherein the said heat dissipating structure is formed at the interface between the said lining and the said carrier-plate.

2. Disc brake pad according to claim 1 wherein said heat dissipating structure is formed in the said lining and/or in the said carrier-plate, at the interface between said the lining and the said carrier-plate.

3. Disc brake pad according to claim 1 wherein the lining and/or the carrier-plate comprise grooves that form holes for which axes are along directions substantially parallel to the plane of the friction surface, after the said lining has been installed on the said carrier-plate, these holes being through holes, such that air can pass freely through them.

4. Disc brake pad according to claim 3 wherein the axes of the said holes are parallel to a given direction which corresponds to the direction of moving air close to said pad.

5. Disc brake pad according to claim 1, wherein the said heat dissipating structure comprises projections around the periphery of the carrier plate, the said projections being preferably provided with cooling fins.

6. Disc brake pad according to claim 1, wherein said heat dissipating structure comprises bars made of a material conducting heat better than the material from which the parts that contain these bars are made, in the said lining and/or said the carrier-plate, at the interface between the lining and the carrier-plate.

7. Disc brake pad according to claim 6 wherein the said bars are located in the housings formed by the said holes formed at the interface of the said lining and the said carrier-plate.

8. Disc brake pad according to claim 6 wherein the said bars are hollow and form through holes such that air passes freely through them.

9. Disc brake pad according to claim 1, wherein the length of the said bars is greater than the length of the housings formed in the pad to contain them.

10. Disc brake pad according to claim 9 wherein the said bars are provided with projections which provide an increased exchange surface, typically cooling fins.

11. Disc brake pad according to claim 1, additionally comprising a piece of sheet metal acting as a heat shield protecting the brake cylinder, the braking fluid and the piston, said piece of sheet metal being typically inserted between the carrier-plate and the piston, between the lining and the carrier-plate or between the carrier-plate and a piece of sheet metal fixed to the carrier-plate and designed to come into contact with the piston.
